(19) United States
(12) Patent Application Publication
(10) Pub. No.: US 2015/0345739 A1
(43) Pub. Date: Dec. 3, 2015

(54) Light Fixture System

(71) Applicants: Skylar Lee Rigsby, Thomas, OK (US); Dean McSpadden, Weatherford, OK (US)

(72) Inventors: Skylar Lee Rigsby, Thomas, OK (US); Dean McSpadden, Weatherford, OK (US)

(21) Appl. No.: 14/725,046

(22) Filed: May 29, 2015

Related U.S. Application Data
(60) Provisional application No. 62/004,631, filed on May 29, 2014.

(51) Int. Cl. F21V 5/04; F21V 29/70; F21K 99/00; F21V 23/00

(52) U.S. Cl. CPC F21V 5/04; F21V 23/003; F21V 29/70; F21K 9/50; F21Y 2101/02

(57) ABSTRACT

A lighting system having a driver to output an electric charge, a plurality of conduits connected to the driver to carry the electric charge, and a plurality of light fixtures, Each of the light fixtures are connected to a single conduit, The light fixtures have a thermal plate comprising a mounting orifice and a conduit orifice, a light emitting diode connected to the conduit to transmit light in response to receiving the electric charge from the driver, and an opaque trim member connected to the thermal plate. The light emitting diode is disposed within the cavity. A lens is connected to the trim member and allows light to pass from the light emitting diode to outside the cavity only through the lens member.

### CROSS REFERENCE TO RELATED APPLICATION

This application claims the benefit of U.S. provisional patent application Ser. No. 62/004,631, tiled on May 29, 2014, the entire contents of which are incorporated herein by reference.

### FIELD

The present invention relates generally to light fixtures and specifically to tight fixtures for light emitting diodes.

### SUMMARY

The present invention is directed to a lighting system. The lighting system comprises a driver to output an electric charge, a plurality of conduits connected to the driver to carry the electric charge, and a plurality of light fixtures. Each light fixture is connected to a single conduit. The light fixtures comprise a thermal plate, a light emitting diode, a trim member, and a lens member. The thermal plate comprises a mounting orifice and a conduit orifice. The light emitting diode is connected to the conduit to transmit light in response to receiving the electric charge from the driver. The trim member is connected to the thermal plate. The trim member defines a cavity and comprises an opaque material. The light emitting diode is disposed within the cavity. The lens member is connected to the trim member and allows light to pass from the light emitting diode to outside the cavity only through the lens member,

The present invention is also directed to a lighting system comprising a. driver to output an electric charge, a conduit connected to the driver to early the electric charge, and, a light fixture. The light fixture is connected to the conduit. The light fixture comprises a thermal disk, a light emitting diode, a truncated conical trim member and a dome-shaped lens member. The thermal disk comprises a mounting orifice and a conduit orifice disposed at a center of the thermal disk. The light emitting diode is supported on the thermal plate and connected to the conduit to transmit light in response to receiving the electric charge from the driver. The truncated conical trim member is connected to the thermal disk. The trim member defines a cavity and comprises an opaque material. The light emitting diode is disposed within the cavity. The dome-shaped lens member is connected to the trim member and allows light to pass from the light emitting diode to outside the cavity only through the lens member.

### BRIEF DESCRIPTION OF THE DRAWINGS

FIG. 1 is diagrammatic representation of the lighting system of the present invention.

FIG. 2 is an exploded view of a light fixture of the present invention.

FIG. 3 is a top view of a thermal plate used in the lighting system of FIG. 1.

### DESCRIPTION OF THE PREFERRED EMBODIMENT

For many years recessed lighting has been popular in homes and businesses. Often owners retrofit structures to have recessed lighting because they prefer the aesthetics of recessed lights. Additionally, owners often desire to relocate lighting within an office or dwelling but cannot because of the large expense and construction mess and clean-up required to relocate and rewire light fixtures. Thus, there is a need to lighting systems and fixtures that allow owners and designers flexibility in the location and movement of lighting as needs or living conditions change.

The present invention is directed to an improved lighting system using light emitting diodes (“LEDs”) powered from a central driver at low voltage. Use of LEDs in the lighting system of the present invention is advantageous because they allow the system to be scalable and require a lower amount of electricity to produce essentially the same illumination effect. For example, a light fixture of the lighting system may consume ten Watts of electricity and provide illumination equivalent to a sixty Watt light bulb.

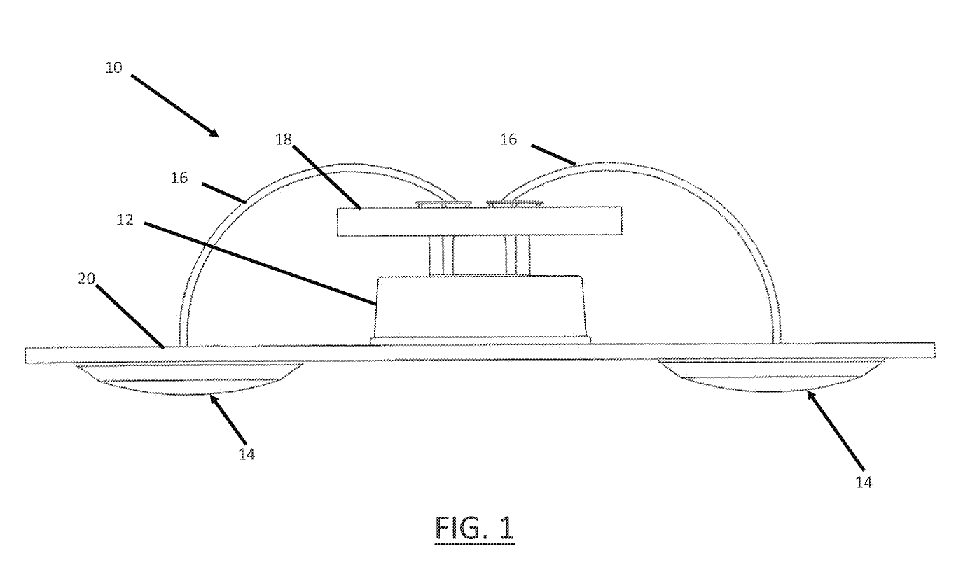

Turning now to the figures and specifically to FIG. 1, a lighting system 10 comprising a driver 12 and a plurality of light fixtures 14 is shown. The driver 12 receives a voltage from an external power source (not shown) and distributes an electric charge to the light fixtures 14. Thus, the lighting system is scalable to drive anywhere from one to ten light fixtures from a single driver. The electric charge may be transmitted to the light fixtures by a plurality of conduits 16 connected to the driver 12. Each light fixture is preferably connected to a single conduit 16. Each conduit may comprise a standard LED rated shielded copper wire, The conduits 16 may pass through a mounting bracket 18 connected to the drive 12. The mounting bracket 18 may be configured to mount the driver to studs (not shown) used to support dry wall 20.

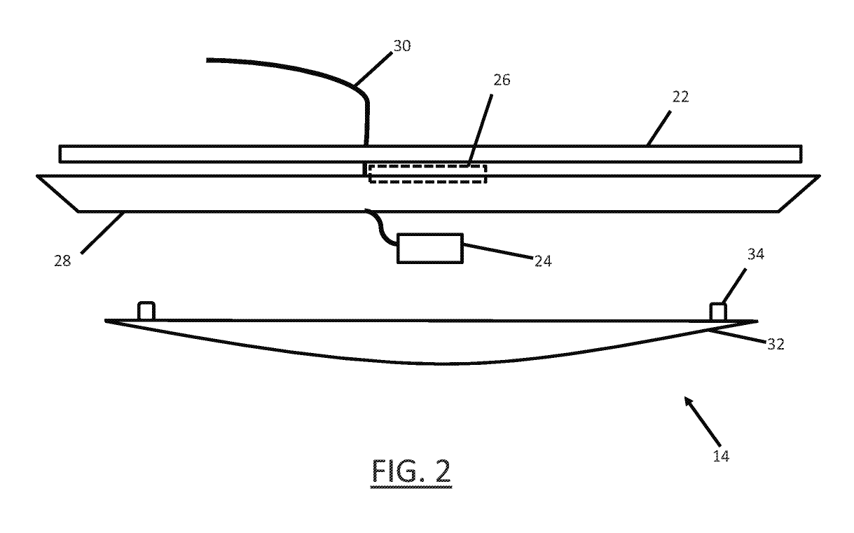

Turning to FIG. 2, an exploded view of one of the plurality of the light fixtures is shown. The light fixture 14 of FIG. 2 is illustrative of light fixtures that may be used in accordance with the present invention. One of skill the art will appreciate that light fixtures of different shapes and sizes may be used with the lighting system disclosed herein without departing from the spirit of the present invention. The light fixture 14 comprises a thermal plate 22 adapted to mount the fixture to a surface such as a ceiling or wall. The thermal plate 22 may comprise a disk having thermal conductive properties that help dissipate heat generated by operation of the LED 24 away from the fixture. The thermal plate may be configured for mounting to a variety of surfaces such as dry wall, concrete, brick, rock, and wood. The thermal plate 22 may also comprise a mount 26 configured to hold the LED 24. As shown in FIG. 2, the trim member 28 may be wider than the thermal plate 22 so that when mounted the trim member covers the thermal plate to hide the thermal plate from view.

Although not required, the light fixture may comprise a trim member 28 connected to the thermal plate 22. The trim member 28 may be fastened to the thermal plate 22 and comprises a truncated cone that defines a cavity. Thus, when assembled the LED 24 is disposed within the cavity when held within mount 26. The trim member 28 is generally constructed from an opaque material that prevents the passage of light through the trim member. A conduit comprising a power cord 30 may connect the LED 24 to the driver 12.

A lens member 32 is connected to the trim member 28 and allows light to pass from the LED 24 to outside the cavity only through the lens member. The lens member 32 may be constructed from a variety of materials; the selection of which depends on the amount of light the user desires the light fixture to emit. Further, the lens member 32 may be constructed from a material that diffuses the light from the LED or may even comprise a colored material. The tens member 32 of FIG. 2 comprises a dome-shaped lens configured to have a wide throw area. A plurality of tab members 34 may be disposed about the periphery of the lens member 32. Tab members 34 function to secure the lens member 32 to the trim member. Alternatively, the lens may be placed within the cavity of the trim member so that it rests within the opening of the trim member. While shown herein as a dome-shaped lens, one skilled in the art will appreciate that the lens member may comprise many different shapes and sizes. For example, the lens member 32 may comprise a square profile or could comprise letters or numbers in the event the lighting system is used for signage.

When assembled, the light fixture may have an overall width of six to 8 inches and preferably a width of 7.25 inches, The lens member may have a width of between four to six inches, Additionally, the height of the light fixture (the distance it extends from the mounting surface) will not need to exceed three-quarters of an inch and could be less than one-half inch.

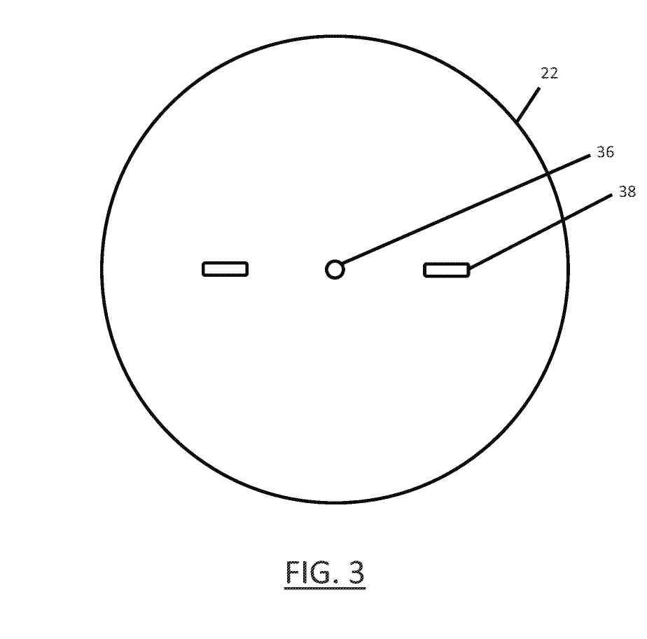

Turning to FIG. 3, the thermal plate 22 is shown from above. The thermal plate comprises a disk that may be less than one inch thick. A conduit orifice 36 is disposed at a center of the disk and two mounting holes 38 are disposed on a diameter of the disk and spaced-apart from the center of the disk. The conduit orifice may be of a small size in the range of ¼″ of an inch. This small size allows for a small hole to be drilled into the mounting surface. Thus, in the event the light fixture is moved in the future on a small hole from the conduit orifice and small holes from the mounting holes in the mounting surface require repair. In contrast, removal of recessed lighting would likely be impossible or require replacement of large sections of the mounting surface. This is a significant advantage of the present invention over prior art lighting systems.

Various modifications can be made in the design and operation of the present invention without departing from its spirit. Thus, while the principle preferred construction and. modes of operation of the invention have been explained in what is now considered to represent its best embodiments, it should be understood that within the scope of the appended claims, the invention may be practiced otherwise than as specifically illustrated and described.

What is claimed is:

1. A lighting system comprising:
a driver to output an electric charge;
a plurality of conduits connected to the driver to carry the electric charge; and
a plurality of light fixtures, each light fixture connected to a single conduit, the light fixtures comprising:
a thermal plate comprising a mounting orifice and a conduit orifice;
a light emitting diode connected to the conduit to transmit light in response to receiving the electric charge from the driver;
a trim member connected to the thermal plate, the trim member defining a. cavity, the trim member comprising an opaque material;
wherein the light emitting diode is disposed within the cavity; and
a lens member connected to the trim member, the lens member allowing light to pass from the tight emitting diode to outside the cavity only through the lens member.

2. The lighting system of claim 1 wherein the thermal plate comprise a disk; wherein the conduit orifice is disposed at a center of the disk and a plurality of mounting orifices are disposed along a diameter of the disk.

3. The lighting system of claim 2 wherein the disk comprises a thermal conductive material to dissipate heat away from the light emitting diode.

4. The lighting system of claim 1 wherein the trim member is fastened to the thermal plate and comprises a truncated cone.

5. The lighting system of claim 1 wherein the lens member comprises a dome-shaped lens configured to have a wide throw area.

6. The lighting system of claim 5 wherein the lens member further comprises a plurality of tab members disposed about a periphery of the lens.

7. The lighting system of claim I wherein the thermal plate comprises a mount configured to hold the light emitting diode.

8. The lighting system of claim 1 wherein the cavity defined by the thermal plate, the lens member, and the trim member is sealed to be rated for wet location.

9. The lighting system of claim 1 wherein the driver is connected to an external power source and regulates a voltage to each of the plurality of light fixtures.

10. The lighting system of claim 1 wherein the lens member may comprise a square profile.

11. A lighting system comprising:
a driver to output an electric charge;
a conduit connected to the driver to carry the electric charge; and
a light fixture connected to the conduit, the light fixture comprising:
a thermal disk comprising a mounting orifice and a conduit orifice disposed at a center of the thermal disk;
a light emitting diode supported on the thermal plate and connected to the conduit to transmit light in response to receiving the electric charge from the driver;
a truncated conical trim member connected to the thermal disk, the trim member defining a cavity, the trim member comprising an opaque material;
wherein the light emitting diode is disposed within the cavity; and
a dome-shaped lens member connected to the trim member, the lens member allowing light to pass from the light emitting diode to outside the cavity only through the lens member.

12. The lighting system of claim 11 wherein a plurality of mounting orifices are disposed along a diameter of the disk.

13. The lighting system of claim 12 wherein the disk comprises a thermal conductive material to dissipate heat away from the light emitting diode.

14. The lighting system of claim 11 wherein the lens member further comprises a plurality of tab members disposed about a periphery of the lens.

15. The lighting system of claim 11 wherein the thermal plate comprises a mount configured to hold the light emitting diode.

16. The lighting system of claim 11 wherein the cavity defined by the thermal plate, the lens member, and the trim member is sealed to be rated for wet location.

17. The lighting system of claim 11 wherein the driver is connected to an external power source and regulates a voltage to each of the plurality of light fixtures.
